(19) United States
(12) Patent Application Publication
(10) Pub. No.: US 2002/0122454 A1
(43) Pub. Date: Sep. 5, 2002

(54) Laser module and method of manufacturing the same

(75) Inventors: Hideyuki Nasu, Tokyo (JP); Yuji Kato, Tokyo (JP); Akira Mugino, Tokyo (JP); Hideyuki Ohmura, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 09/797,577

(22) Filed: Mar. 5, 2001

(51) Int. Cl. H01S 3/04; H01S 3/08

(52) U.S. Cl. 372/102; 372/36

(57) ABSTRACT

A laser module in which a fiber grating fixed in a ferrule is used as a distributed reflector to stabilize the oscillation characteristic of a laser by maintaining the original reflection characteristics of the fiber grating. Only one or more portions of a fiber grating that do not include a grating, namely, a non-grating forming portion(s), are fixed to a ferrule by solder. The portion of the fiber that includes the grating, i.e., the grating forming portion, is not subject to metal deposition. Thus the deformation and/or degradation of a grating due to heat from the solder is decreased or completely avoided.

### BACKGROUND OF THE INVENTION

1. Field of the Invention

The present invention relates to a laser module for use in an optical transmitter in optical information communications, and a method of manufacturing the same.

2. Discussion of the Background

An exemplary conventional laser module is described in Japanese Laid-open Patent Application No. Hei 8-286077, the contents of which are incorporated herein by reference. This laser module includes a fiber grating as an external distributed reflector that is fixed within a laser package. In this example, the grating portion of the fiber is inserted into a ferrule so that it may be fixed within the ferrule.

The fiber is commonly fixed to the surrounding ferrule (made of, e.g., metal) by soldering. The fixation process begins with the evaporation deposition of a metal upon the fiber to coat the portion of the fiber that is to be attached to the ferrule. The fiber is then inserted into the metal ferrule, and the space between the ferrule and the portion of the fiber which has been coated by metal is filled with solder while heating. The grating portion is thus fixed within the ferrule.

However, the grating is commonly distorted by this soldering. Since the grating is heated when the space between the grating portion and the ferrule is filled with solder, and then cooled during solidification of the solder, thermal stress often distorts the grating. Moreover, since both the applied heat and the cooling of the solder commonly occurs non-uniformly, the distortion of the grating due to thermal stress is also non-uniform.

Prior to soldering, the refractive index of the fiber grating changes at a certain pitch along the longitudinal fiber direction. The more uniform the pitch of these refractive index variations, the narrower the bandwidth of the light reflected at a given angle. However, the stress distortion due to (non-uniform) heating and/or cooling described above distorts this pitch. As a result, the reflection spectrum of the grating is broadened, often being made asymmetrical and commonly deviating from the grating manufacturer's specifications. An exemplary empirical measurement shown in FIG. 16 illustrates an asymmetrical reflection spectrum having two peaks. As illustrated, the fiber grating does not retain either its original reflectance or half-width. Laser modules constructed using such a fiber grating with an asymmetrical reflection spectrum will display unstable oscillation characteristics due to the presence of plural reflection peaks, and are commonly unsuitable for high precision applications.

### SUMMARY OF THE INVENTION

The present invention has been made in view of the above problem. Thus, an object of the present invention is to provide a laser module in which a fiber grating with a ferrule is used as a distributed reflector in which the oscillation characteristic of the laser remains stable. Moreover, another object of the invention is to provide a method of manufacturing the same.

In order to attain the objects above, a laser module that includes a laser, a supporting member for supporting the fiber grating, and a fiber including a fiber grating that remains substantially undistorted by manufacturing is described. The laser and the fiber grating together constitute a pair of resonators. The fiber itself has a non-grating forming portion and a grating forming portion in the longitudinal direction. In an exemplary embodiment, a metal layer is formed on at least a part of the non-grating forming portion of the fiber. This metal layer is used to fix the fiber grating to the supporting member while preventing deformation of the fiber grating due to applied stress. As a result, the fiber grating attached to the supporting member can be used as a distributed reflector to stabilize the oscillation characteristic of the laser.

According to a second embodiment of the present invention, the non-grating forming portion of the fiber is subdivided. into a first non-grating forming portion and a second non-grating forming portion. The first non-grating forming portion, the grating forming portion, and the second non-grating forming portion are arranged in the longitudinal direction along the fiber in this order. Moreover, at least one of the first and the second non-grating forming portions have a metal layer formed thereon, while the grating forming portion of the fiber remains substantially free of the metal layer. This metal layer is fixed to the supporting member by soldering. Moreover, since the grating forming portion of the fiber is substantially free of the metal layer, solder does not contact the grating forming portion during fixation. This limits thermal transport from the (hot and cooling) solder to the grating forming portion, and the grating forming portion undergoes minimal distortion. As such, the grating forming portion can substantially retain the optical properties possessed after manufacturing.

Thus, by simply defining the boundaries of the metal layers along the fiber, the location of the solder in the longitudinal direction along the fiber can also be defined. This method does not rely upon precision positioning of the solder relative to the grating and/or supporting member, but rather exploits the differences in interfacial tension between a metal solder/metal layer interface and a metal solder/grating forming portion interface to define the ultimate location of the solder.

According to a third aspect of the present invention, only one non-grating forming portion, which is to the side of the grating forming portion in the fiber grating, is fixed to a supporting member by soldering to the metal layer. Thus, the laser module according to the third aspect of the present invention advantageously eliminates any tensile stress due to soldering both ends of the grating forming portion to a supporting member.

According to a fourth aspect of the present invention, a groove portion is formed in the supporting member in order to receive the fiber grating. Thus, the fiber grating can stably be fixed in the supporting member.

According to a fifth aspect of the present invention, a method of manufacturing a laser module is provided. This method includes fixing a laser to the body of a module, forming a grating in a grating forming portion of an optical fiber that includes both a non-grating forming portion and a grating forming portion along the longitudinal direction of the optical fiber, and marking the vicinity of the junction between the non-grating forming portion and the grating forming portion along the optical fiber. By marking the junction between the non-grating forming portion and the grating forming portion, a metal layer can readily be formed over at least a part of the non-grating forming portion. This can be followed by soldering and fixing the fiber to the supporting member at the metal layer to thereby fix a fiber grating to the supporting member. After fixation, the position of the laser and the fiber grating can be adjusted so that the laser and the fiber grating constitute a pair of resonators having a desired resonance wavelength. The fiber grating along with the supporting member can then be fixed to the body of the module. In this case, the fiber grating forming step and the metal layer forming step can be carried out in any order, followed by attachment to the supporting member, adjusting the position of laser relative to the fiber grating (and supporting member), and fixation of the supporting member. This allows the use of the fiber grating (attached to the supporting member) as a distributed reflector while the grating forming portion remains unstressed. The oscillation characteristics of the laser are thus stabilized using a highly adaptable laser module manufacturing process.

### BRIEF DESCRIPTION OF THE DRAWINGS

In the accompanying drawings:

Figs. 1A and 1B illustrate an exemplary fiber that includes a grating at various stages during the process of forming the fiber grating by a manufacturing method in accordance with the first exemplary embodiment of the present invention;

FIGS. 2A and 2B illustrate an exemplary fiber that includes a grating at further stages during the process of forming a metal layer on the fiber grating by a manufacturing method in accordance with the first exemplary embodiment of the present invention;

FIG. 3 is a structural diagram showing an exemplary package module in accordance with the first exemplary embodiment;

FIGS. 4A to 4C illustrate an exemplary fiber grating at various stages during attachment to a supporting member by the manufacturing method in accordance with the first embodiment of the present invention;

FIG. 5 illustrates an exemplary fiber with a grating that has an end face that has been processed to form a lens;

FIGS. 6A to 6D illustrate an exemplary fiber (which will ultimately include a grating) at various stages during formation of a metal layer by a manufacturing method in accordance with the second embodiment of the present invention;

FIG. 7 illustrates an exemplary fiber with a grating at a stage during manufacture in accordance with the second embodiment of the present invention;

FIGS. 8A and 8B illustrate an exemplary fiber with a grating at a stage during manufacture in accordance with the third embodiment of the present invention;

FIGS. 9A and 9B illustrate an exemplary fiber with a grating at a stage during manufacture where a metal layer has been deposited in accordance with the third embodiment of the present invention;

FIG. 10 illustrates and exemplary fiber with a grating during attachment to a supporting member in accordance with the third embodiment of the present invention;

FIGS. 11A to 11C illustrate an exemplary fiber that is to have a grating at various stages during deposition of a metal layer during manufacture in accordance with the fourth embodiment of the present invention;

FIG. 12 illustrates the attachment of a fiber with a grating to a supporting member during manufacture in accordance with another embodiment of the present invention;

FIG. 13 illustrates a package module in accordance with the second embodiment of the present invention;

FIG. 14 illustrates a package module in accordance with the third embodiment of the present invention;

FIG. 15 illustrates a package module in accordance with the fourth embodiment of the present invention; and

FIG. 16 graphically illustrates the reflection spectrum of a fiber grating after deformation of the fiber grating due to stress caused by soldering.

### DETAILED DESCRIPTION OF THE PREFERRED EMBODIMENTS

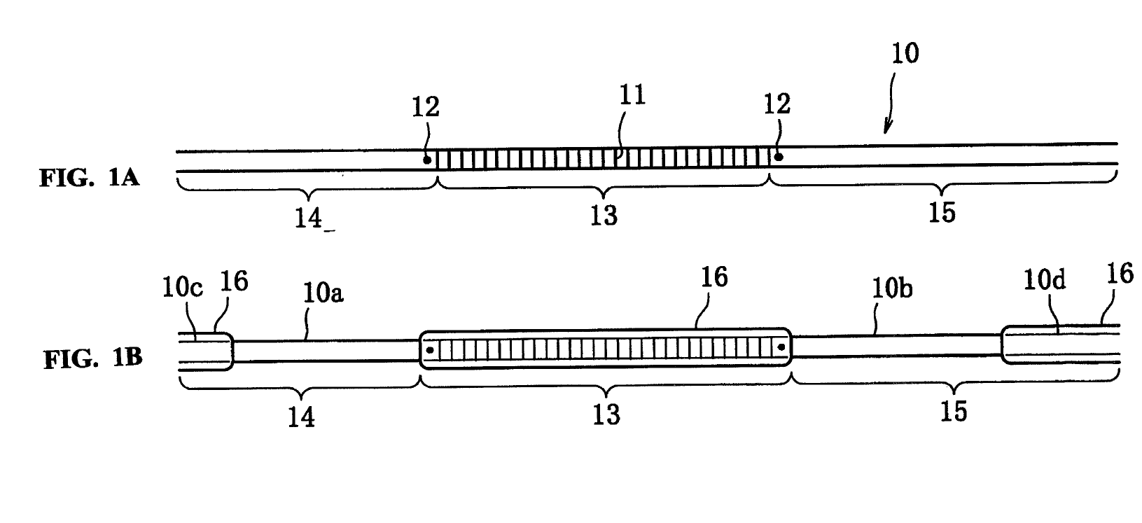

A more complete appreciation of the present invention and many of the attendant advantages thereof will be readily obtained as the same become better understood by reference to the following detailed description when considered in connection with the accompanying drawings, wherein FIG. 1A to FIG. 15 illustrate embodiments of various aspects of a laser module of the present invention at various stages during manufacture.

### FIRST EMBODIMENT

FIG. 1A to FIG. 5 illustrate a laser module of the present invention and a fiber that includes a grating at various stages during manufacture in accordance with the first embodiment of the present invention. The manufacturing process commences with a fiber grating forming step and a metal layer forming step, and proceeds to a laser fixing step, a supporting member attaching step, and a supporting member fixing step, sequentially.

FIG. 1A illustrates a fiber immediately after a grating has been formed thereon in a fiber grating forming step. The fiber grating forming step yields a fiber 10 that includes a grating 11 with a desired reflection spectrum. The grating 11 is formed by irradiating an optical fiber with ultraviolet light. The grating 11 is difficult to see after irradiation, so portions of the fiber surface that correspond to the right and left ends of the grating 11 are marked with markings 12. These markings 12 thus demarcate the boundaries between the portion 13 where the grating 11 is formed (hereinafter referred to as grating forming portion) and the portions 14 and 15 where the grating 11 is not formed (hereinafter referred to as non-grating forming portions). The non-grating forming portions are further denoted as a first non-grating forming portion 14 and a second non-grating forming portion 15. The fiber 10 thus includes the first non-grating forming portion 14, the grating forming portion 13, and the second non-grating forming portion 15. These are arranged in the longitudinal direction along the fiber 10 in this order.

Then, as shown in FIG. 1B, a resist agent 16 is applied to the fiber surface over the grating forming portion 13. The non-grating forming portions 14 and 15 have fiber surface portions 10a and 10b, respectively, which are to be fixed to a ferrule 18 made of a metal. In this illustrative embodiment, the ferrule 18 forms a supporting member. Further details regarding the ferrule 18 will be provided later. The rest of the fiber surfaces, namely, the surfaces denoted by 10c and 10d, do not require metal deposition in order to perform the present invention. Thus, the surfaces 10c and 10d are coated by the resist agent 16. The resist agent 16 is formed by using a viscous resin material.

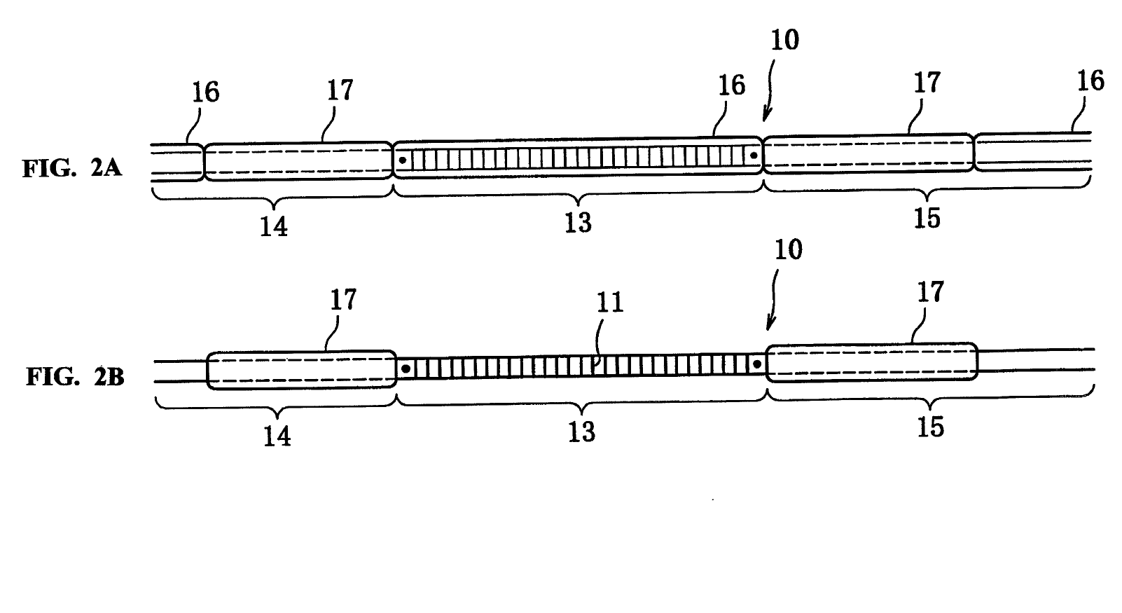

The next step is the metal layer forming step. As shown in FIG. 2A, the fiber 10 can be set in an evaporation apparatus (not shown) that deposits a metal on to the fiber 10. This results in a metal layer 17 being formed on the fiber 10. After metal deposition is complete, the fiber 10 is washed with water or other washing agent such as alcohol (not shown) to wash out the resist agent 16. Naturally, other processes beside evaporation can be used to deposit metal layer 17, including but not limited to sputtering and electroless deposition. However, evaporation provides the broadest selection of materials that may form metal layer 17.

After metal deposition (e.g., evaporation), as shown in FIG. 2B, the fiber 10 has fiber surface portions 10a and 10b that are to be fixed to the ferrule 18 and retain metal layer 17. However, the fiber surface of the grating forming portion 13 where the grating 11 is formed remains free of metal layer 17. These steps are carried out with markedly improved work efficiency owing to the markings 12 described above, especially relative to cases where no markings have been made.

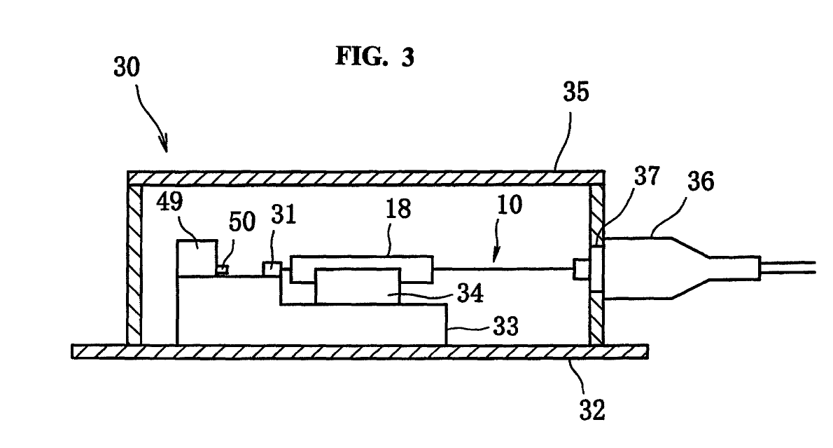

The next step is the so-called laser fixing step and is shown in FIG. 3. A laser diode 31 is fixed in a package module 30 that forms the body of a module in accordance with the present invention. In order to prevent heat from changing the refractive index and gain band of an active layer, the laser diode 31 is mounted on a heat sink 33 that is placed on a substrate 32. The output characteristics of the laser diode are thus stabilized. The laser fixing step may be carried out at any point during the manufacturing process as long as it precedes the supporting member fixing step that will be described later.

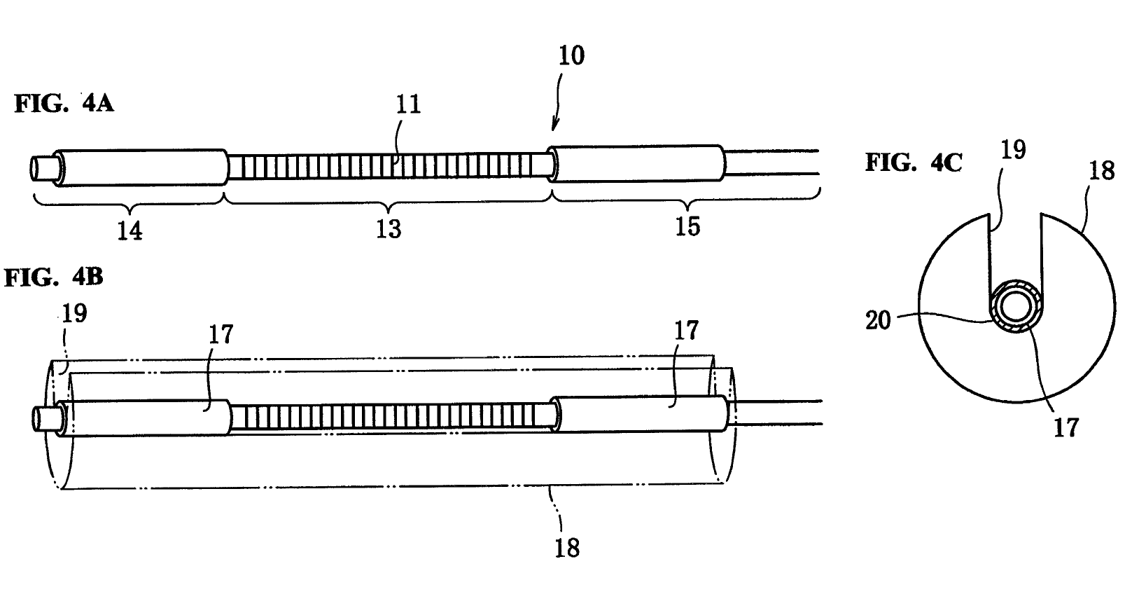

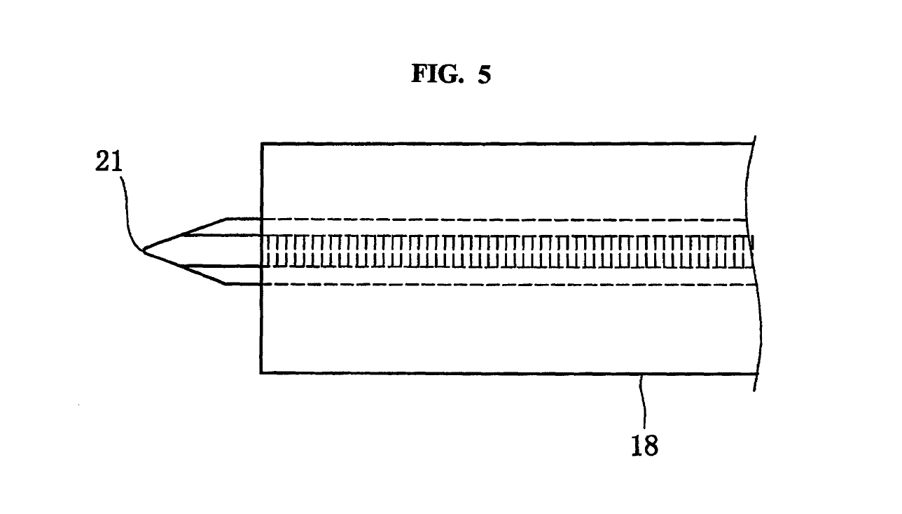

In the supporting member attaching step, a groove 19 is formed to receive and fix the fiber 10, as illustrated in FIG. 4A. A metal ferrule 18 with a cross section perpendicular to the long axis shaped into the form of a letter U is formed. The groove 19 is open at the side of the ferrule over the entire length of the ferrule so as to facilitate the insertion of the fiber 10. The fiber 10 is first inserted into the groove 19 of the ferrule 18 and fixed temporarily (see FIG. 4B). Then solder 20 is poured from above into the groove 19, targeting the portions of the fiber 10 where the metal layer 17 has been formed. The solder 20 flows into the spaces between the groove 19 and the portions of the fiber 10 where the metal layer 17 has been formed, and then cools and solidifies to fix the fiber 10 to the ferrule 18 (see FIG. 4C). The solder 20 occupies substantially only the volume surrounding the metal layer 17 since the solder 20 does not wet the fiber surfaces that remain uncoated by metal layer 17. Thus, the heated (and cooling) solder 20 does not come into physical contact with the grating forming portion 13, and thermal transport between the grating forming portion 13 and the solder 20 is minimized. Thus, nonuniform stresses due to thermal transport between the solder and the grating forming portion 13 are eliminated, along with the consequences of such stresses including more than one peak in the reflection spectrum of the grating. Thus, by way of the present invention, the fiber grating can be fixed in the groove 19 of the ferrule 18 without being damaged.

Subsequently, the fiber 10 attached to the ferrule 18 is cut at a point distal to the ferrule 18, and a desired fiber end face 21 is produced. Example fiber end faces 21 include, e.g., a spherical end lens or a hyperbolic lens, as shown in FIG. 5. The fiber 10 with the ferrule 18 will be fixed in the package module 30 shown in FIG. 3 in the next supporting member fixing step. The position of the laser diode 31 and the fiber grating can be adjusted so that they form a pair of resonators having a desired resonance wavelength before the fiber 10 with the ferrule 18 is fixed in the package module 30. It is relatively easy to adjust the oscillation wavelength of the resonator because the stresses due to soldering are minimal at the grating 11, and the spectrum of the grating 11 after fixation remains substantially identical to the spectrum after manufacture of the grating 11.

In some cases, the Bragg wavelength of the fiber 10 may display increased susceptibility to temperature after the grating is attached to the ferrule 18. This is presumably due to the fact that the coefficient of thermal expansion of the ferrule 18 is actually larger than that of the material, e.g., silica, that forms the fiber 10. If this is the case, expansion of the ferrule 18 will, in effect, stretch the fiber 10 and change the pitch of the variation in refractive index. To avoid this, in one embodiment, the fiber 10 and the ferrule 18 are placed on the heat sink 33 to release heat through a fixing jig 34. The fiber 10 with the ferrule 18 and the laser diode 31 are thus placed on the same heat sink 33. This makes it possible to simultaneously control the temperature of the fiber grating and the laser diode, thereby stabilizing the oscillation wavelength in the package module 30.

The fiber 10 and the ferrule 18, the laser diode 31, the heat sink 33, and the fixing jig 34 can be sealed in an air-tight package 35. In order to achieve air-tight sealing of the package 35, the fiber 10 can be passed through a hole in a connecting jig 36. In other words, the connecting jig 36 includes a hole 37 through which the fiber 10 is passed. The connecting jig 36 can be connected to the bulkhead of the package 35 by soldering to lead the fiber 10 out of the package 35.

The result is a laser module in which the fiber 10 with the ferrule 18 and the laser diode 31 are sealed in the package module 30. The ferrule is thus attached to the non-grating forming portions of the fiber grating and is fixed thereto by soldering. This substantially prevents the application of stress to the grating during soldering. Therefore, the reflection spectrum of the grating can be maintained, and other desirable grating characteristics can be retained. When the fiber grating with the ferrule as above is used as an external distributed reflector, the oscillation characteristics of the laser are stabilized, which increases the reliability of the laser diode. Incidentally, reference symbols 49 and 50 in FIG. 3 denote a photo diode (PD) mounting base and a PD for monitoring the output of light by the laser diode, respectively.

### SECOND EMBODIMENT

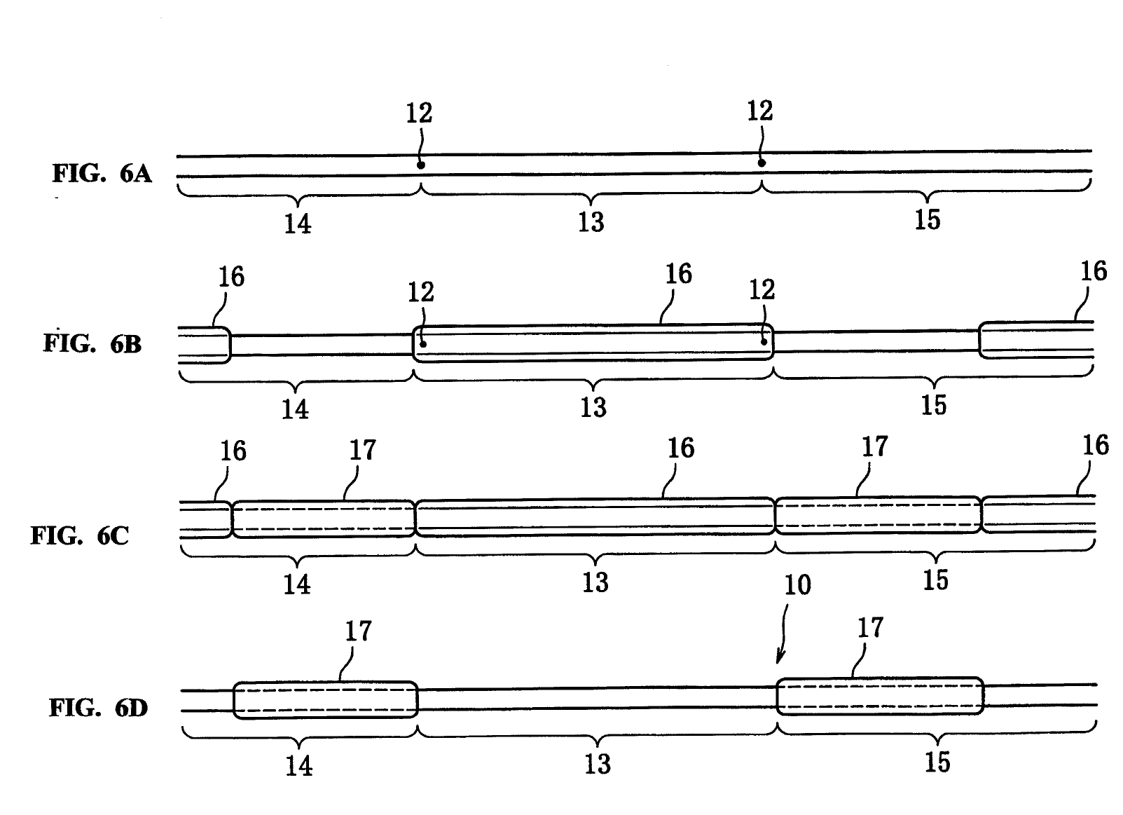

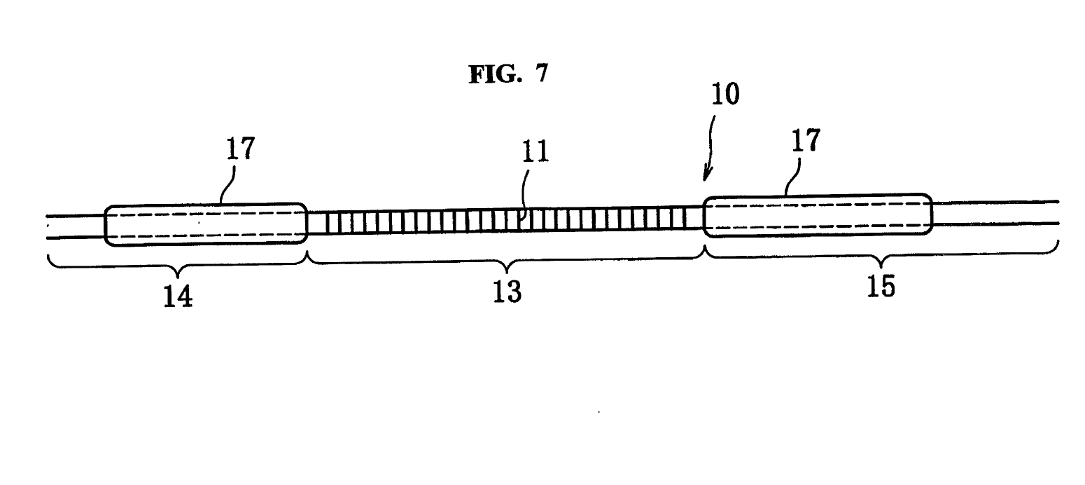

FIGS. 6A to 6D and FIG. 7 illustrate a fiber grating at various stages during manufacture in accordance with the second embodiment of the present invention. In the second embodiment, a metal layer is first formed at select portions of a fiber, and then a fiber grating is formed on the fiber. Thereafter, a laser is fixed to, e.g., a heat sink, and the fiber grating is attached to a supporting member and the supporting member is fixed to, e.g., the same heat sink. The laser fixing step can be the same as described in regard to the first embodiment, and hence a detailed description thereof will be omitted from the description of the second embodiment, as well as any subsequent embodiments.

In a metal layer forming step, markings 12 are first made on the fiber surface at positions corresponding to the right and left boundaries of a portion of the fiber 10 that is to become the grating forming portion 13, as shown in FIG. 6A. In this instance, the grating forming portion 13 has a predetermined desirable length. Since the reflection spectrum of the grating 11 is also a function of the length of the grating 11, a predetermined desirable length for the grating forming portion 13 has to be set for the grating 11. The markings 12 clearly demarcate the boundaries of the grating forming portion 13.

Then, as shown in FIG. 6B, a resist agent 16 is applied to the area between the markings 12 that will ultimately contain the grating 11. The resist agent 16 is also applied to some of the non-grating forming portions 14 and 15, leaving portions of these non-grating forming portions 14 and 15 exposed. The optical fiber is next set in an evaporation apparatus (not shown) and metal is deposited to form the metal layers 17, as shown in FIG. 6C. After metal deposition (e.g., evaporation), a fiber 10 can be washed with water or other washing agent such as alcohol to remove the resist agent 16, to yield a fiber as seen in FIG. 6D. In some embodiments, the markings 12 are also washed off at this point. The optical fiber is then irradiated with ultraviolet light to produce a desired grating 11 in the grating forming portion 13 between the metal layers 17.

The resulting fiber grating illustrated in FIG. 7 thus includes a fiber 10 having fiber surface portions 10a and 10b (covered with a metal layer 17) that are to be fixed to a ferrule. The fiber 10 also includes a grating forming portion 13 where a grating 11 has been formed that remains substantially free of the metal layer 17. In this embodiment, a ferrule 18 is fixed to the portions of the thus manufactured fiber 10 where the metal layer 17 has been formed by soldering. This makes it possible to maintain the reflection spectrum of the grating 11 substantially as it was after manufacture, with the desired grating characteristics. An end face of the fiber 10 can be processed to form a lens and the thus processed fiber grating is set in a laser module. When such a laser module is used as an external distributed reflector, the oscillation characteristic of the laser is stabilized and provides enhanced reliability.

In this embodiment, the formation of the grating 11 is performed after the metal layer is formed. This provides another advantage in that, if the portions where the metal layers 17 are formed are irradiated with ultraviolet light due to, e.g., misalignment with the light source, then the metal layers 17 block the ultraviolet irradiation and no gratings are formed in the optical fiber beneath the metal layers 17. Thus, this embodiment significantly reduces the precision of alignment of the fiber 10 relative to the ultraviolet light source during formation of the grating 11.

### THIRD EMBODIMENT

The first and second embodiments illustrate examples where metal is deposited upon two longitudinally distinct portions of a fiber 10. However, the present invention is not limited thereto, and it is also possible to deposit metal on only one portion of the fiber. The following embodiments are examples that provide such fibers.

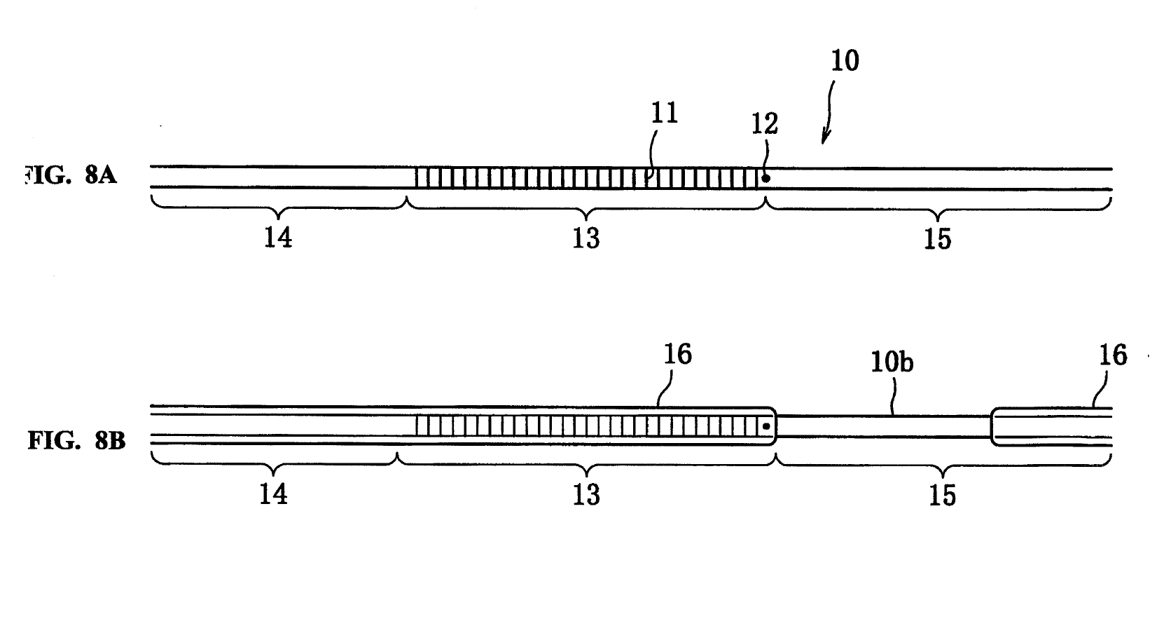

FIGS. 8A to 10 illustrate an exemplary fiber grating at various stages during manufacture in accordance with the third embodiment of the present invention. In the third embodiment, a fiber grating is formed and a metal layer deposited before the laser is fixed to a support (and all subsequent steps are performed), as in the first embodiment. During formation of the fiber grating, a grating 11 with a desired reflection spectrum is formed by irradiating an optical fiber 10 with ultraviolet light, to yield the structure illustrated, e.g., in FIG. 8A. At this point, the fiber surface is marked at one end of the grating 11 with a marking 12. The marking 12 clearly indicates the position of one end of the grating 11.

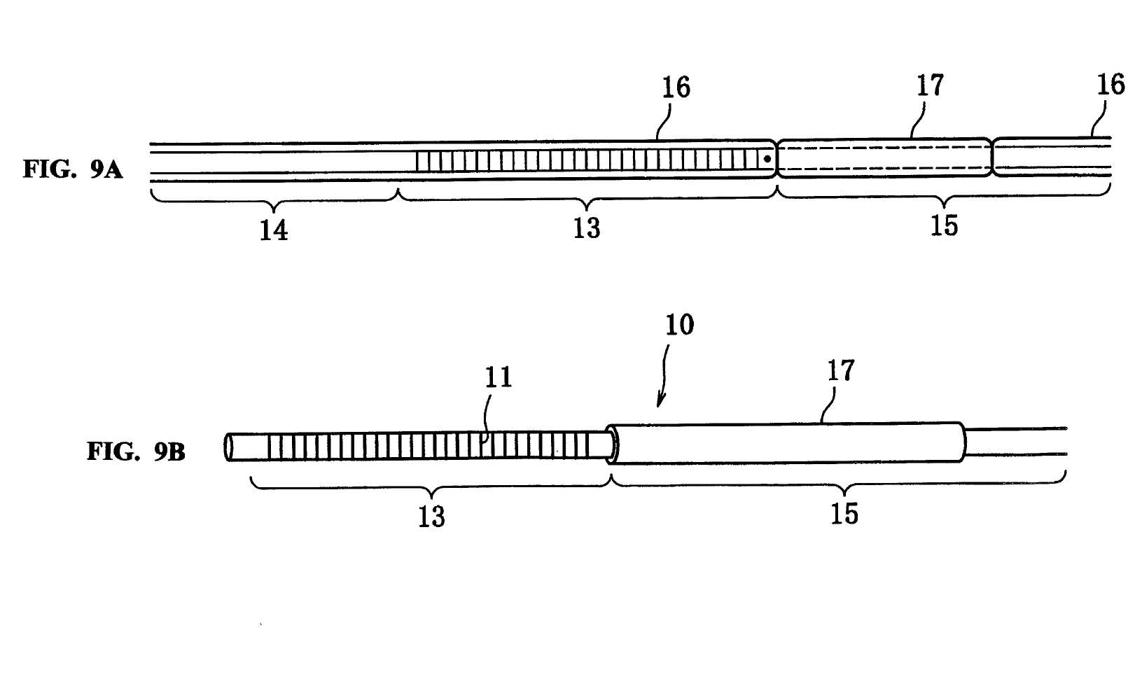

Next, a resist agent 16 is applied to the fiber surface of a grating forming portion 13 of the fiber 10 and to the fiber surfaces of non-grating forming portions 14 and 15, except for a portion lob which is to have metal deposited thereon by, e.g., evaporation (see FIG. 8B). A metal layer is then deposited by, e.g., setting the fiber 10 in an evaporation apparatus and evaporating metal upon the fiber 10 to form metal layer 17, as shown in FIG. 9A. The fiber 10 that has been subjected to metal deposition is then washed with a washing agent to wash out the resist agent 16, and yield the structure illustrated in FIG. 9B. Thus, the fiber 10 has a non-grating forming portion 15 that is to be fixed to a ferrule 18 and has been subjected to metal evaporation to form the metal layer 17, as well as a grating forming portion 13 where the grating 11 has been formed and substantially no metal has been deposited.

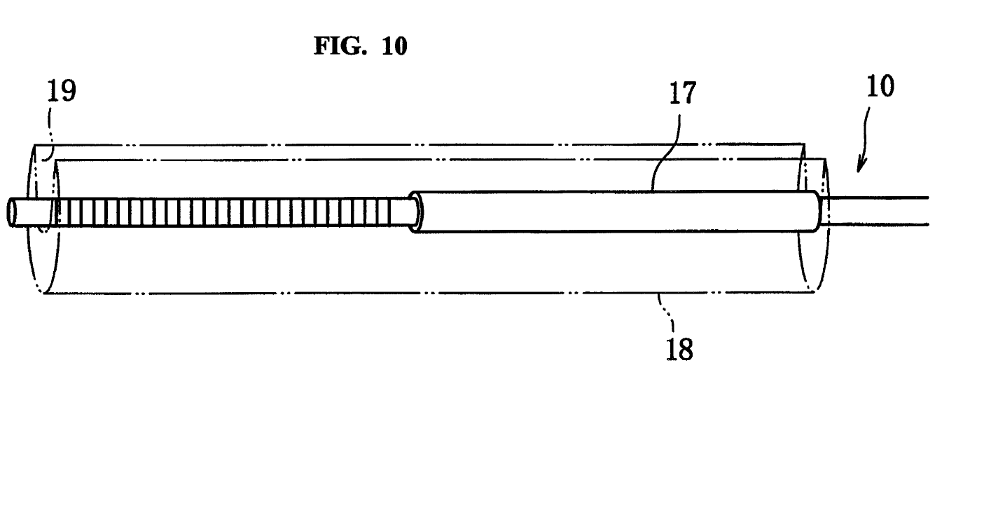

In this embodiment, a ferrule 18 can be attached to the portion of the thus manufactured fiber 10 where the metal layer 17 has been formed, and can be fixed thereto by soldering (see FIG. 10). Although it is unlikely, tensile stress may be applied to the grating forming portion when the fiber grating is soldered to the ferrule at both ends of the grating forming portion, as in the first embodiment. This tensile stress may arise when the soldered portions drawn the fiber in opposite (longitudinal) directions. If tensile stress is applied to the grating forming portion, the pitch of the grating may be changed away from the desired pitch, and the resulting fiber grating cannot provide a desired oscillation characteristic when used in a laser module.

In contrast, only one non-grating forming portion (on the side of the grating 11) is fixed to the ferrule by way of the metal layer 17 in the third embodiment. Therefore, the grating 11 does not receive the tensile stress caused by soldering to both sides of the grating forming portion. The grating 11 in this embodiment is thus advantageous in that it can more reproducibly provide a desired oscillation wavelength characteristic when used in a laser module.

### FOURTH EMBODIMENT

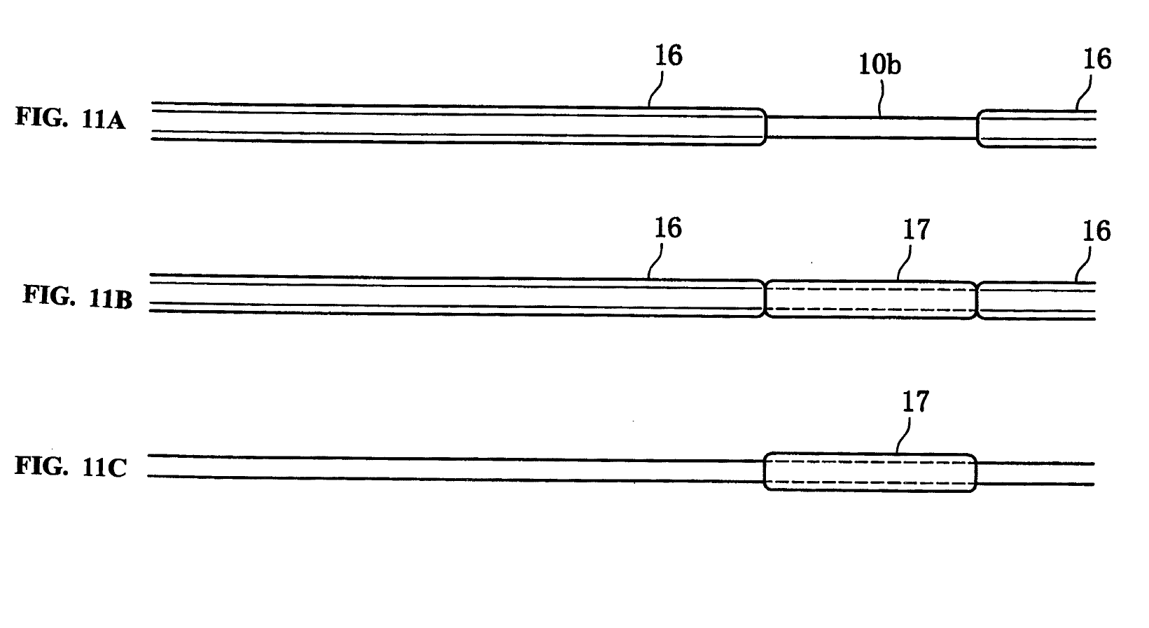

FIGS. 11A to 11C illustrate a fiber grating during various stages of manufacture in accordance with a fourth exemplary embodiment. First, an appropriate portion of the fiber surface is designated for metal deposition (e.g., evaporation). In the illustrated example, this appropriate portion is the fiber surface portion 10b. A resist agent 16 is applied to the fiber surface except for the fiber surface portion 10b on which metal deposition is to be performed (see FIG. 11A). The optical fiber can be set in, e.g., an evaporation apparatus to conduct metal evaporation and to form metal layer 17. An example of the fiber structure after metal deposition (e.g., evaporation) is seen in FIG. 11B. The resist agent 16 can then be washed out using a washing agent. This process thus also forms a fiber 10 includes a metal layer 17 in a desired position (see FIG. 11C). This allows the position that has been subject to metal deposition (e.g., evaporation) to be located anywhere along the optical fiber. In the next step of fiber grating formation, an end of the portion that has been subjected to metal deposition, or a portion of the optical fiber somewhat distant from the aforementioned end, is irradiated with ultraviolet light. A grating 11 having a desired reflection spectrum thus can be formed, to yield a fiber grating as seen, e.g., in FIG. 9B. Once again, since the metal layer 17 is substantially opaque to ultraviolet light, there is no need to precisely align the ultraviolet lamp relative to the metal layer 17 prior to irradiation. Rather, any overlap of the ultraviolet light that is to form the grating 11 with the metal layer 17 will not affect the fiber 10.

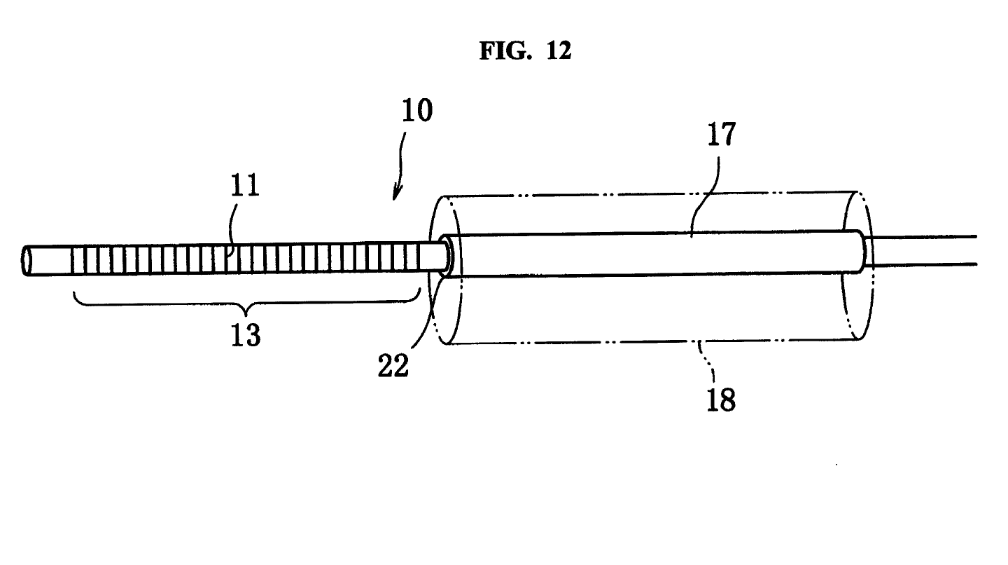

In the third and fourth embodiments, the ferrule 18 may have a groove 19 that extends along the grating 11 and the metal layer 17 of the fiber 10 in the longitudinal direction, as shown in FIG. 10. However, it is preferred for the groove 19 to extend along only the metal layer 17 as shown in FIG. 12, since the ferrule 18 can be shorter and the material costs thereof can be reduced.

FIG. 12 illustrates another embodiment of the present invention. A ferrule 18 may have a through hole 22 in the longitudinal direction, as shown in FIG. 12. When attaching to a supporting member, a fiber 10 is inserted into the through hole 22, and liquid solder is placed between the through hole 22 of the ferrule 18 and a portion of the fiber grating where metal layer 17 is formed. The fiber 10 is then fixed in the ferrule 18 when the solder cools.

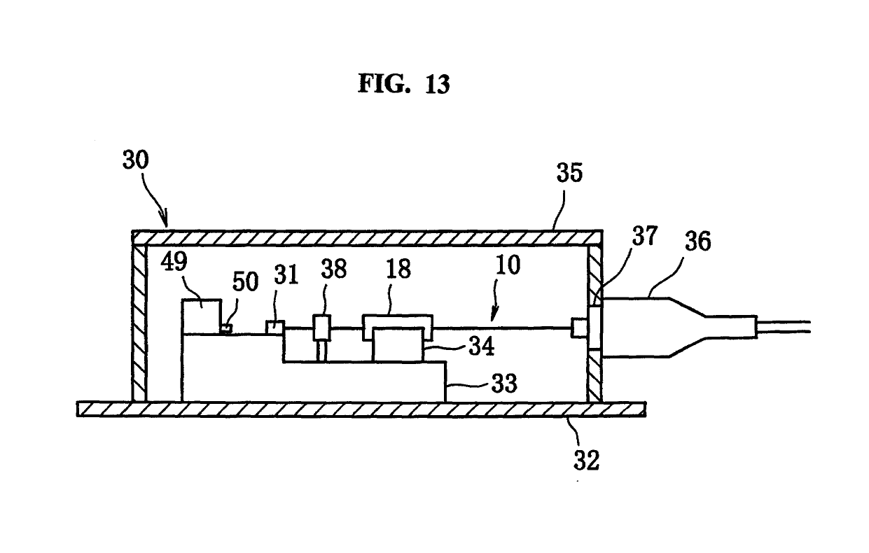

If a portion (e.g., a grating forming portion 13) of the fiber 10 which protrudes from the ferrule 18 shown in FIG. 12 is too long, it is possible that the optical axis may be shifted due to bending of the portion of the fiber 10 which protrudes from the ferrule 18. This may happen under its own weight, or due to a mechanical vibration. As a countermeasure, as shown in FIG. 13, the fiber 10 with the ferrule can be placed on a heat sink 33 having a fixing jig 34. Then, the protruding portion of the fiber 10 can be supported by a supporting jig 38 placed on the heat sink 33 when the fiber 10 is fixed in a package module 30 during supporting member fixation. This prevents bending or vibration of the fiber 10 or the vibration and thereby avoids a shift of the optical axis.

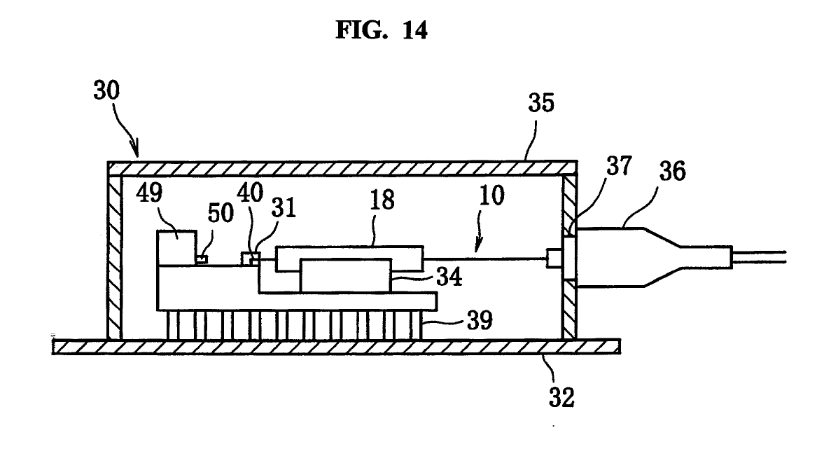

The fiber 10 with the ferrule and a laser diode 31 are influenced by heat which may cause changes in oscillation wavelengths and instability. If this is the case, the fiber 10 with the ferrule 18 and the laser diode 31 can be placed on the same Peltier cooler 39 and a thermistor 40 can be arranged in the vicinity of the laser diode 31, as shown in FIG. 14. The thermistor 40 detects the temperature and can be used to control the current of the Peltier cooler 39 so that the fiber 10 and the laser diode 31 are maintained at a desired temperature. This suppresses any temperature increases due to heating in order to maintain a more constant oscillation wavelength and stabilize the characteristics of the laser in this embodiment.

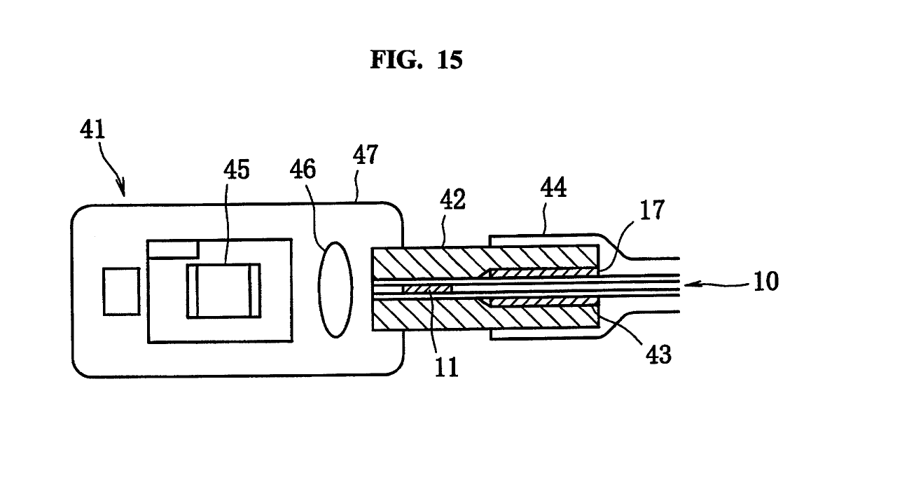

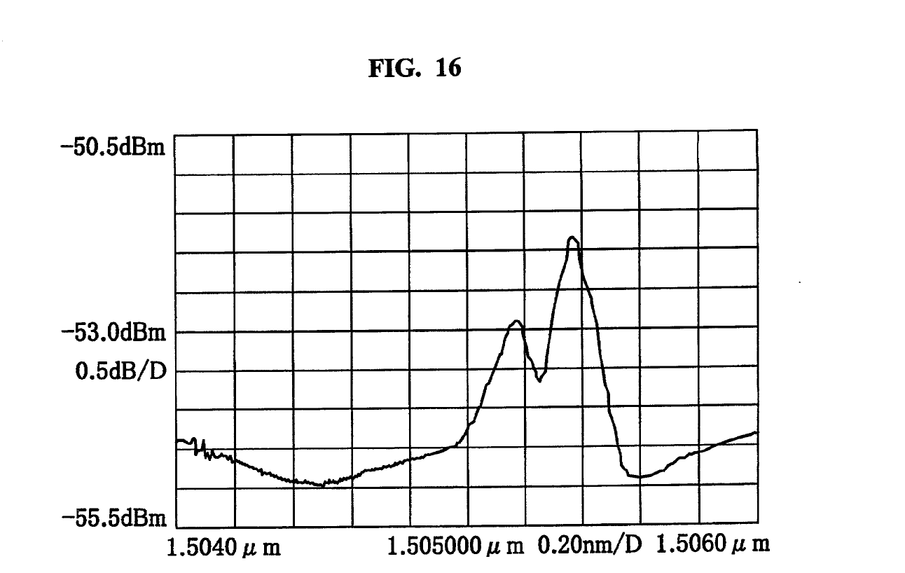

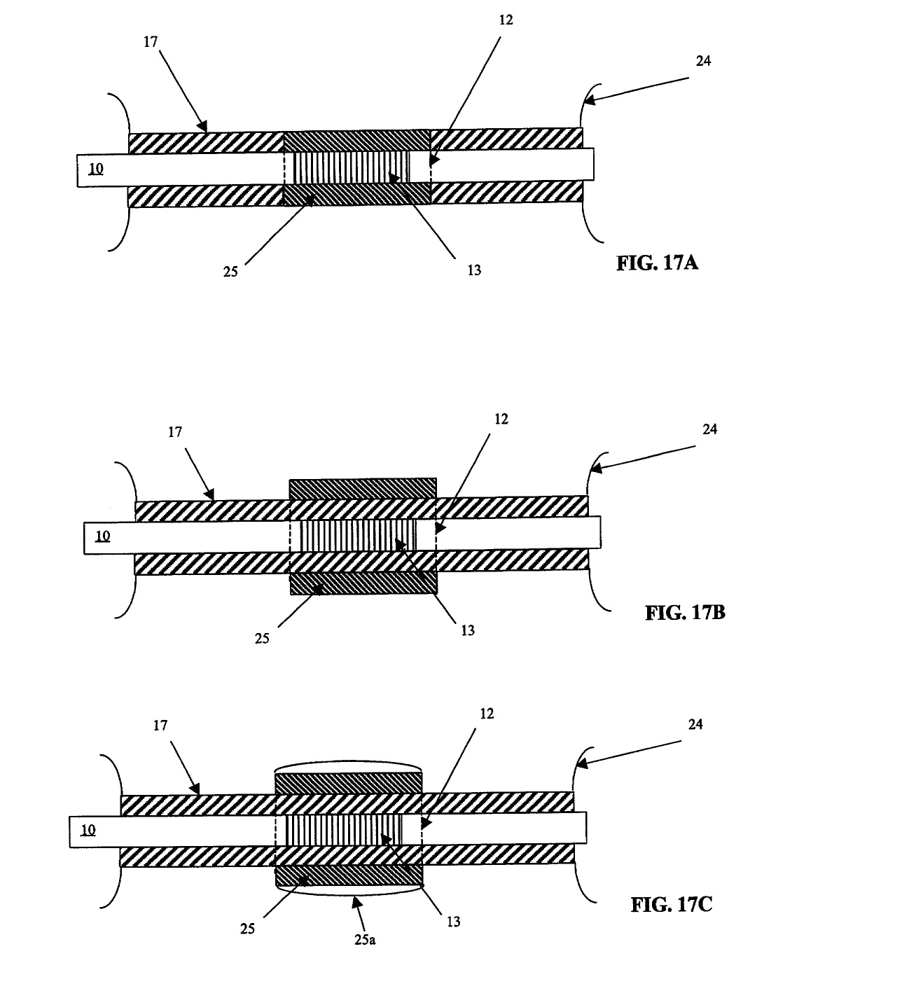

The present invention may also be applied to the case where the fiber 10 is placed in a connecting jig 42 that is made of a metal and is attached to a package module 41, as shown in FIG. 15. That is, the connecting jig 42 acts as the supporting member of the present invention. The connecting jig 42 is formed to have a cylindrical shape, for example, and has a through hole 43 through which the fiber 10 is inserted and supported. The diameter of the through hole 43 is larger at its outer end than at the end that is connected to the package module 41, thereby allowing the through hole 43 to contain the portion of the fiber where the metal layer 17 is formed. The inserted portion where the metal layer 17 is formed is fixed to the connecting jig 42 by soldering. The connecting jig 42 is partially fitted to a cover 44 made of a resin. Note that an end face of the fiber is not processed to form a lens.

The connecting jig 42 is fixed to a package 47 after the position of the optical axis is adjusted through a semiconductor laser 45 and a lens 46 which are placed in the package module 41 The connecting jig is attached to a non-grating forming portion of the fiber grating and is fixed thereto by soldering in this embodiment. The stress due to soldering is thus not applied to the grating 11, and thus the reflection spectrum upon manufacture of the grating 11 can be maintained and a desired grating characteristic can be obtained. When the fiber grating with the connecting jig is used as an external distributed reflector, the oscillation characteristic of the laser is stabilized and a laser module with a high reliability can be provided.

The present invention is not limited to these embodiments, but various modifications can be made without departing from the spirit of the present invention. For instance, the fiber grating may be formed before or after the metal layer is deposited, as long as the order chosen causes no incongruence. The laser fixation can be conducted at any point as long as it precedes the supporting member fixation. In this way, the method of manufacturing a laser module in accordance with the present invention is highly variable, making it possible to manufacture a laser module by a process suited to the installation conditions of the manufacturing equipment, the manufacturing environment, or the like.

In this embodiment, processing an end face of the fiber to form a lens may be conducted at any point as long as it is before the fiber 10 is attached to the package module 30. The resist agent of the present invention is not limited to the one that is mentioned in the above embodiments (a viscous resin material), but the resist agent may also be a thermally curable resin material, a UV curable resin material, a thermally curable-UV releasable resin material, or the like.

Specifically, when a thermally curable resin material is used as the resist agent, it is applied to a portion of the fiber grating surface as described above. The fiber is then heated to set the resist agent. The fiber on which the resist agent has been cured is placed in a deposition (e.g., evaporation) apparatus to subject the fiber to metal deposition (e.g., evaporation). After the metal deposition (e.g., evaporation), the portion of the fiber where the resist agent has been set is immersed in a releasing solution to peel off the set resist agent. The fiber grating is thus completed.

When a UV curable resin material is used for the resist agent, there are two kinds of methods for manufacturing the fiber grating. According to a first method, the UV curable resin is applied to a portion of the fiber grating surface as described above. Then the resist agent is irradiated with ultraviolet light to be cured. The fiber on which the resist agent has been cured is placed in a deposition (e.g., evaporation) apparatus to subject the fiber to metal deposition (e.g., evaporation). Thereafter, the portion of the fiber where the resist agent has been set is immersed in a releasing solution to peel off the set resist agent. The fiber grating is thus completed.

According to a second method, the UV curable resin is applied to a relatively large portion of the fiber grating surface. Then, only the grating 11 (or the portion of the fiber where the grating 11 is to be formed) is irradiated with ultraviolet light to cure the resist agent. The rest of the resist agent that has not been cured is washed out. Then the fiber on which the resist agent has been cured is placed in a deposition (e.g., evaporation) apparatus to subject the fiber to metal deposition (e.g., evaporation). Thereafter, the portion of the fiber where the resist agent has been set is immersed in a releasing solution to peel off the set resist agent. The fiber grating is thus completed.

When a thermally curable-UV releasable resin is used for the resist agent, the thermally curable-UV releasable resin is applied to the fiber grating surface as described above. The fiber to which the resist agent is applied is then heated to set the resist agent. The fiber grating surface except for the portion where the grating has been or will be formed is irradiated with ultraviolet light. The resist agent in the portion that has been irradiated with ultraviolet light is washed out with bath liquid, leaving the resist agent only covering the grating 11 (or portion where the grating 11 is to be formed). The fiber on which the resist agent has been cured is placed in a deposition (e.g., evaporation) apparatus to subject the fiber to metal deposition (e.g., evaporation). After the metal deposition (e.g., evaporation), the portion of the fiber where the resist agent has been set is immersed in a releasing solution to peel off the set resist agent. The fiber grating is thus completed.

The supporting member of the present invention can take any structure as long as the structure chosen is capable of supporting the fiber grating. Other than the U-shaped ferrule shown in the above embodiments, a V-shaped ferrule, a plate without the groove portion, for example, may also be used.

As described above, the present invention provides a laser module comprising at least:

a laser;

a fiber grating including a non-grating forming portion and a grating forming portion in a longitudinal direction, said laser and said fiber grating forming a pair of resonators;

a supporting member configured to support said fiber grating; and

metal layer formed on at least a part of the non-grating forming portion of said fiber grating, wherein:

said fiber grating and said supporting member are fixed to the metal layer; and said grating forming portion remaining unfixed to said supporting member.

In the present invention a method of manufacturing a laser module, comprising:

producing a fiber grating, including

marking a junction between a non-grating forming portion and a grating forming portion in an optical fiber,

depositing a metal layer in the non-grating forming portion,

forming a grating in the grating forming portion of the optical fiber,

soldering and fixing said optical fiber and a supporting member at the metal layer, leaving said grating forming portion of the optical fiber unfixed to said supporting member,

wherein the depositing and forming step are carried out in any order;

fixing a laser to a body of said laser module

adjusting the position of said fiber grating relative to said laser to form a pair of resonators having a desired resonance wavelength; and

fixing said fiber grating relative to said laser.

Obviously, numerous modifications and variations of the present invention are possible in light of the above teachings. It is therefore to be understood that within the scope of the appended claims, the invention may be practiced otherwise than as specifically described herein.

1. A laser module comprising:
a laser;
a fiber grating including a non-grating forming portion and a grating forming portion in a longitudinal direction, said laser and said fiber grating forming a pair of resonators;
a supporting member configured to support said fiber grating; and
a metal layer formed on at least a part of the non-grating forming portion of said fiber grating, wherein:
said fiber grating and said supporting member are fixed to the metal layer; and
said grating forming portion remaining unfixed to said supporting member.

2. The laser module according to claim 1, wherein:
non-grating forming portion comprises a first non-grating forming portion and a second non-grating forming portion; the first non-grating forming portion, the grating forming portion, and the second non-grating forming portion being arranged sequentially in the longitudinal; and
said metal layer being formed on at least one of the first non-grating forming portion and the second non-grating forming portion, said at least one of the first non-grating forming portion and the second non-grating forming portion being fixed to said supporting member by soldering to the metal layer.

3. The laser module according to claim 2, wherein one of the first non-grating forming portion and the second non-grating forming portion being fixed to said supporting member by soldering to the metal layer.

4. The laser module according to claim 1, wherein said supporting member comprises a groove portion formed to receive said fiber grating.

5. A method of manufacturing a fiber grating, comprising:
marking a junction between a non-grating forming portion and a grating forming portion in an optical fiber;
depositing a metal layer in the non-grating forming portion;
forming a grating in the grating forming portion of the optical fiber;
soldering and fixing said optical fiber and a supporting member at the metal layer, leaving said grating forming portion of the optical fiber unfixed to said supporting member,
wherein the depositing and forming step are carried out in any order.

6. The method of forming a laser module, comprising:
producing a fiber grating, including
marking a junction between a non-grating forming portion and a grating forming portion in an optical fiber,
depositing a metal layer in the non-grating forming portion,
forming a grating in the grating forming portion of the optical fiber,
soldering and fixing said optical fiber and a supporting member at the metal layer,
leaving said grating forming portion of the optical fiber unfixed to said supporting member,
wherein the depositing and forming step are carried out in any order;
fixing a laser to a body of said laser module
adjusting the position of said fiber grating relative to said laser to form a pair of resonators having a desired resonance wavelength; and
fixing said fiber grating relative to said laser.

7. A method of manufacturing a fiber grating, comprising:
determining a first portion of a fiber to contain a grating;
depositing a metal layer on said fiber outside said first portion;
producing said grating along said first portion;
fixing said fiber to a support using said metal layer on said fiber outside said first portion.

8. The method according to claim 7, further comprising marking said fiber to indicate said determined first portion.

9. The method according to claim 7, further comprising:
coating said first portion of the fiber with a resist agent;
depositing a second metal layer on said first portion of said fiber;
releasing said resist agent to remove said deposited second metal layer from said first portion of the fiber.

10. The method according to claim 7, wherein said depositing step comprises evaporating a metal layer on said fiber.

11. The method according to claim 7, wherein said producing step comprises UV-irradiating said fiber to produce said grating along said first portion.

12. The method according to claim 7, wherein said fixing step comprises soldering said fiber to said support using said metal layer on said fiber outside said first portion.

13. The method according to claim 7, wherein:
said depositing step comprises depositing said metal layer on said fiber on one longitudinal side of said first portion; and
said fixing step comprises soldering said fiber to said support at said one side.

14. The method according to claim 13, further comprising a step of fixing another longitudinal of said fiber to a supporting jig in a laser module configured to support said another longitudinal side.

15. The method according to claim 7, wherein:
said depositing step comprises depositing said metal layer on said fiber on two longitudinal sides of said first portion; and
said fixing step comprises soldering said fiber to said support at said two sides.

16. The method according to claim 15, further comprising a step of maintaining said support at a substantially uniform temperature.

17. The method according to claim 16, wherein said maintaining step comprises contacting said support to a heat sink.

18. The method according to claim 7, wherein said support comprises a ferrule.

19. The method according to claim 7, wherein said producing step is performed prior to said depositing step.

20. A fiber grating, comprising:
means for guiding light;
means for reflecting a bandwidth of said light;
means for supporting said means for guiding;
means for fixing said means for guiding to said means for supporting, said means for fixing not in contact with said means for reflecting.
